(19) United States
(12) Patent Application Publication
(10) Pub. No.: US 2008/0281438 A1
(43) Pub. Date: Nov. 13, 2008

(54) Critical dimension estimation

(75) Inventor: Scott A. Middlebrooks, Portland, OR (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Model Predictive Systems, Inc.

(21) Appl. No.: 10/831,768

(22) Filed: Apr. 23, 2004

(51) Int. Cl. G05B 13/02; G06F 19/00

(52) U.S. Cl. 700/29; 700/121

(57) ABSTRACT

Estimating a state of a critical dimension system comprises inputting a critical dimension measurement and inferring the state of the system based on a model of the critical dimension system and the critical dimension measurement.

### FIELD OF THE INVENTION

The present invention relates generally to control systems. More specifically, a technique for estimating critical dimension is disclosed.

### BACKGROUND OF THE INVENTION

Regulating the critical dimension achievable in semiconductor device manufacture is an important goal. There are many variables that affect the critical dimension of the device, including exposure dose, focus, tilt, bake temperature, etc. However, due to the complexity associated with adjusting multiple variables, current processing systems typically improve critical dimension by adjusting a single variable. Also, the critical dimension of devices under processing is usually controlled through a trial and error approach. Traditional processing systems typically attempt to adjust the system variables and drive the system to target in a single move. These systems (also referred to as “deadbeat” systems) usually do not account for the disturbances that exist in the system and therefore often include some output error. It would be desirable if processing systems could take disturbances into account and improve system outputs. It would also be useful if processing systems could take into account multiple system variables when driving the system to target.

### BRIEF DESCRIPTION OF THE DRAWINGS

Various embodiments of the invention are disclosed in the following detailed description and the accompanying drawings.

FIG. 1 is a block diagram illustrating a critical dimension system according to one embodiment.

FIG. 2 is a flow chart illustrating a process for regulating critical dimensions according to one embodiment.

FIG. 3 is a diagram illustrating a critical dimension estimator embodiment.

FIG. 4 is a flowchart illustrating an estimation process according to one embodiment.

FIG. 5 is a diagram illustrating another critical dimension system embodiment.

FIG. 6 is a flowchart of a controller process according to another CD controller embodiment.

FIG. 7 is a block diagram illustrating a cascaded critical dimension control system according to one embodiment.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or electronic communication links. In this specification, these implementations, or any other form that the invention may take, may be referred to as techniques. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and invention may be practiced according to the claims without some or all of these specific details. For the purpose of clarity, technical material that is known in the technical fields related to the invention has not been described in detail so that the invention is not unnecessarily obscured.

Various aspects of a critical dimension (CD) control system are disclosed. In some embodiments, a regulator derives an input based on a model of the system in order to converge a predicted critical dimension output with a target. The model may be derived using physical analysis, empirical data, fundamental analysis, or other appropriate methods. In some embodiments, the input is derived by inverting the model by optimizing an objective function subject to constraints. In some embodiments, an estimator is used in conjunction with the regulator to form a controller with feedback. The technique is applicable to various critical dimension control systems, including develop inspect (DI) and final inspect (FI). In some embodiments, two or more controllers are cascaded to control the CD of the overall system.

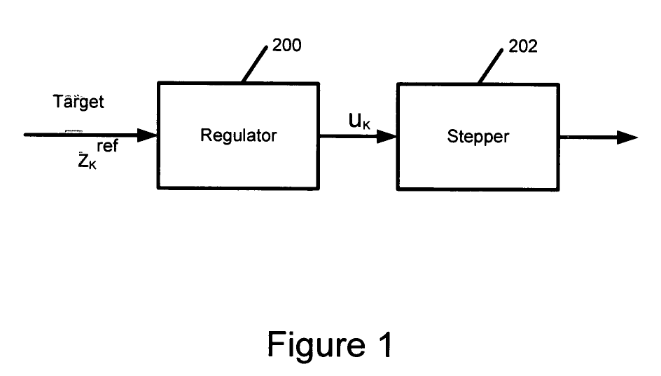

FIG. 1 is a block diagram illustrating a critical dimension system according to one embodiment. As used herein, a critical dimension system refers to a processing system that produces a product (such as a pattern on a wafer or a device) with features that can be measured. Critical dimension refers to characteristics of the processing unit's product, including device line width, feature depth, sidewall angle, device speed, etc. In this example, the CD system includes a lithography stepper 202 and a regulator 200 used to drive stepper 202. For the purpose of illustration, the lithography stepper is used extensively in the following examples, although the techniques are also applicable to other processing units such as etchers, X-ray and electron beam lithography devices.

The stepper and the regulator are arranged in an open-loop configuration. A target denoted as Zₖ^{ref} is sent to regulator 200. The regulator provides an input uₖ to drive stepper 202 to achieve the desired targets. In this example, the input includes settings of stepper 202 such as exposure dose, focus, tilt in x and y, post-exposure bake temperature. The model used to calculate the input may have a functional dependence on resist type, reticle information and/or other appropriate configuration parameters. The output refers to the CD measurement taken on the device processed by the processing unit, including feature size and depth, sidewall angle, etc. The target includes the desired CD for the output of stepper 202. The target, the input and the output of stepper 202 may each include one or more vectors, and each of the vectors may include one or more variables.

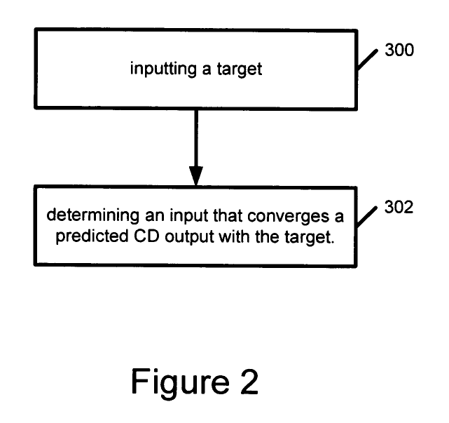

FIG. 2 is a flow chart illustrating a process for regulating critical dimensions according to one embodiment. The process can be used by CD regulators such as the system shown in FIG. 1. In this example, a target representing a desired critical dimension output is provided to the system (300). An input to the processing unit (such as an input to stepper 202 in FIG. 1) is then determined (302) based a system model that predicts the CD of devices processed by the system. The input is determined in such a manner that when the input is applied to the model, the predicted output according to the model converges with the target. In this example, the output refers to measurement taken on the CD of the devices processed by the processing unit, including feature size and depth, sidewall angle, etc.

In some embodiments, the model is derived based on system fundamentals including optical properties of the stepper's exposure system, dynamics of the stepper's mechanical functions, chemical properties of the photo resist used, empirical data, as well as any other appropriate analysis of the system or combinations thereof. For example, in Handbook of Microlithography, Micromachining and Microfabrication volume 1 Microlithography edited by P. Rai-Choudhury, formulas describing light intensity and axis of illumination are presented. These formulas can be used to model the system. The system model may include Fourier transforms, Maxwell's equations, as well as any other appropriate physical, empirical or fundamental analyses. The model may be linear or nonlinear and multivariate.

There are several ways to invert the process model to determine the input such that the predicted output is at a specified target. In some embodiments, a regulator objective function is defined as the difference between the predicted output and the specified target. This objective function is minimized, subject to the model and constraints, in order to determine the input that will regulate the predicted output to target.

In the open-loop example shown in FIGS. 1 and 2, the regulator drives the stepper without any feedback. When the model is a close approximation of the actual stepper, and the predicted output is approximately the same as the measured CD output of the stepper, the open-loop regulator can drive the stepper to generate an output close to target. In some embodiments, however, the predicted output and the measured CD output are different enough that adjustments to the stepper's input are required. In some embodiments, the adjustments are made by adapting the model. In some embodiments, the adjustments are made by providing feedback to the regulator. Details of the feedback configuration are discussed below.

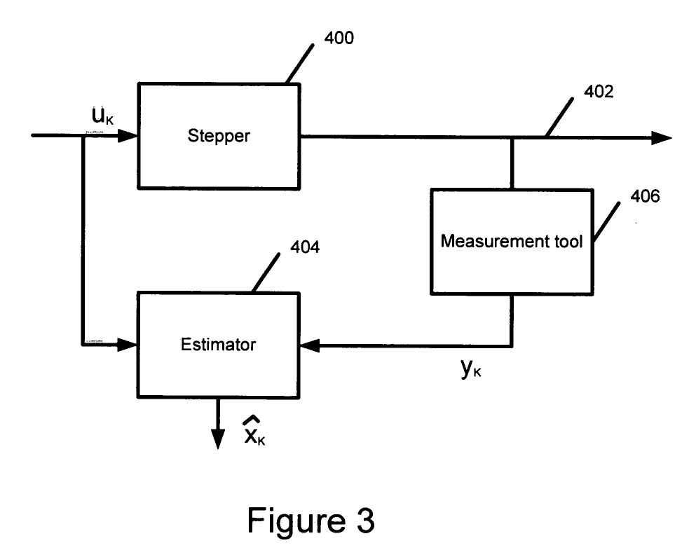

FIG. 3 is a diagram illustrating a critical dimension estimator embodiment. In this example, the input to stepper 400, uₖ, is also sent to an estimator 404. A measurement tool 406 measures the CD of the stepper output, and then sends the measurement, yₖ, to estimator 404. The measurement tool may measure the CD of the device directly, or, it may measure certain aspects of the device (such as device speed) and then derive the CD according to the measurements. In some embodiments, the measurement tool includes a scanning electron microscope (SEM). In some embodiments, the measurement tool employs scatterometry and/or ellipsometry techniques. The measurement may be taken across the wafer, as well as across a die positioned on the wafer. Based on the input, the measurement, and the model of the system, estimator 404 infers an estimated state of the system, \hat{x}_{K}. The model used by estimator 404 in this example is similar to the model used by the regulator shown in FIG. 1.

As used herein, the state includes a vector having one or more parameters that characterize the system, such as the parameters that define the optical system, parameters that describe the kinetics of the resist, as well as process disturbances in the parameters and/or any other appropriate parameters. Although the states and the inputs are related, and in some embodiments the states and the inputs may share certain variables, they are not necessarily equivalent.

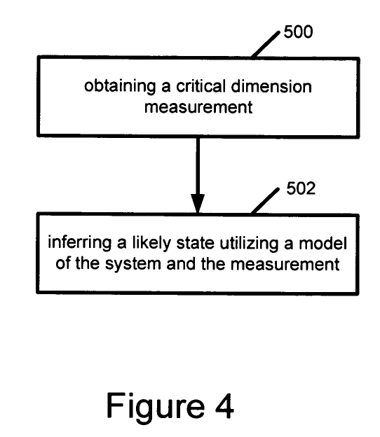

FIG. 4 is a flowchart illustrating an estimation process according to one embodiment. A critical dimension measurement is obtained by a measurement tool (500). Likely states of the system based on a model of the system and the measurement is inferred (502). In some embodiments, an estimator objective function is formulated, and likely states are evaluated based on the objective function. Subject to constraints, the states that minimize the difference between the measured output and the predicted output are determined to be the likely states. The states may be inferred using various state estimation techniques such as moving horizon estimation (MHE), non-linear programming, quadratic programming, as well as recursive techniques such as Extended Kalman Filtering or other appropriate techniques.

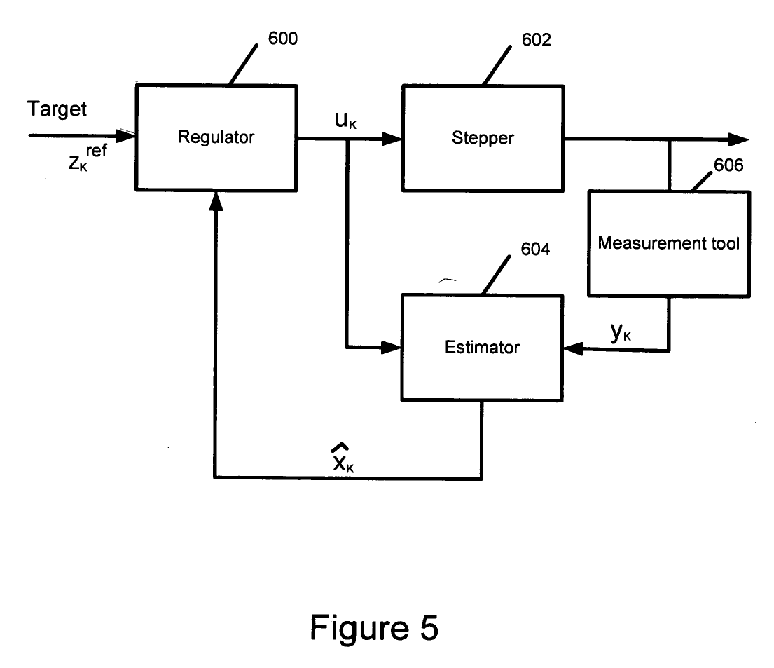

In some embodiments, the regulator and the estimator are combined to form a system with feedback to control the CD. FIG. 5 is a diagram illustrating another critical dimension system embodiment. The system includes a model used to describe the stepper 602. In this example, the model may be expressed as:

$$\frac{d x}{d t} = Ax + Bu + ω \\ y = Cx , \qquad ( 1 )$$

where A and B and C are model coefficients, x represents the states of the system, u represents the input of the system, y represents the output of the system, and ω represents system noise. The model used in the system may vary for different embodiments. For example, it may be a linear function or a nonlinear function. Since the model function and its coefficients are often not perfect representations of the system being controlled, measurements are taken and an estimation process is performed to adapt the model to be a better predictor. Adjustments are derived for the coefficients and sometimes the model function itself. More details of the estimation process are discussed below.

A regulator 600 is used to provide system inputs to drive the system states to desired targets. In this example, the regulator is given a target vector Zₖₚ^{ref} that specifies the goal of the system. Zₖ^{ref} is defined as the target output for the system, including the desired CD output and/or desired states. In this example, a regulator objective function is formulated to express the performance objective of the regulator. The performance objective in this case is to minimize the difference between the predicted output according to the model and the target of the system, subject to constraints. Based on the objective function, the regulator determines the input to the stepper, uk, which includes settings of lithography stepper 602 as well as any other appropriate configuration parameters. The lithography stepper is then configured according to the determined input parameters.

A CD measurement tool 606 measures the wafer after it is processed by stepper 602 and provides a measured output yₖ. An estimator 604 reconstructs the system states and provides an estimated state vector \hat{x}ₖ based on the input of the lithography stepper uₖ, the system model and the measured output yₖ. The estimator is designed to find the most likely states given the model, the inputs, the measured outputs and any constraints. In some embodiments, the estimator finds the most likely states by adjusting the model to fit measurement data the best it can. In some embodiments, the estimator finds the state based on an estimator objective function formulated to express the performance objective of the estimator. In this example, the performance objective of the estimator is to minimize the difference between the measurement and the prediction, subject to constraints.

The estimated states are sent back to regulator 600. Based on the estimated state, the regulator computes a new set of inputs in order to drive the output to tracks Zₖ^{ref} closely. In this example, the estimated state is used as the initial starting point for the optimization process.

Ideally, the estimator would provide the optimal estimated states to the regulator, and the regulator would then provide an input that makes the stepper's output meet the desired target. In real systems, however, the regulator and the estimator are often subject to various constraints that preclude the optimal input and/or state from being usable. For example, an input constraint may indicate that the dose setting is between 0 and 1.0; therefore an optimal input with a dose setting of 5.0 is not reasonable. In some embodiments, the regulator objective function and the estimator objective function explicitly take into account the constraints to derive input and state values that lead the output be as close to the target as possible.

In some embodiments, the constraints of the system are expressed as penalties in the objective function. For instance, if the input is constrained to a range of focus values, the objective function is then defined in such a way that exceeding the range of focus values would incur a penalty. The computation techniques tend to choose input values that stay within the constraints to avoid the penalties. In some embodiments, besides the range of input/state values, deviation from target and rate of change are also constrained using penalties. In some embodiments, the constraints may be relaxed to converge the output closer to target.

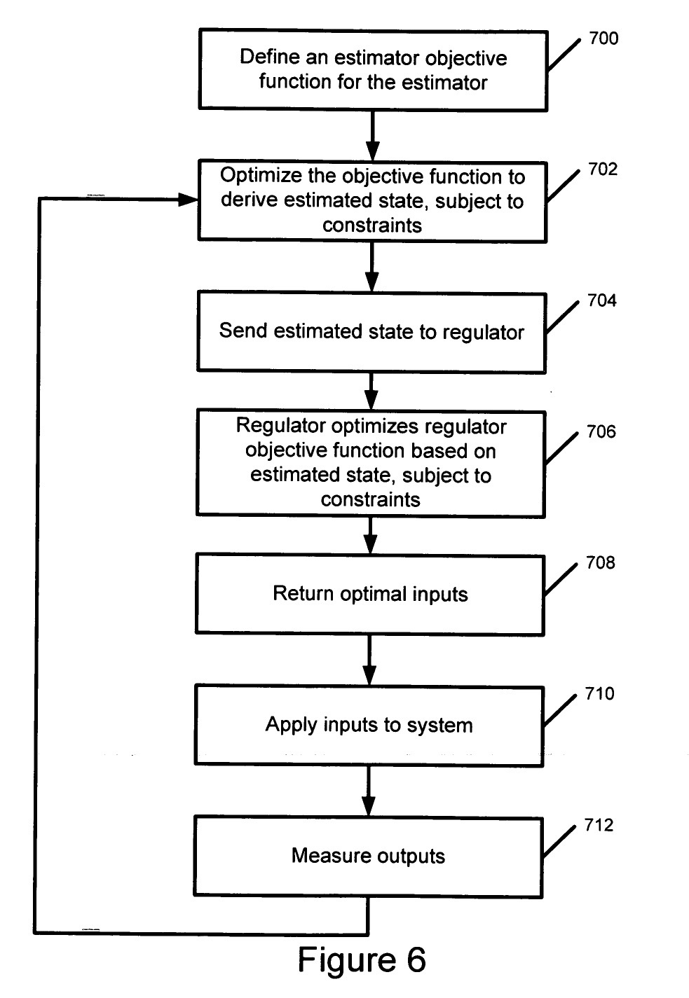

FIG. 6 is a flowchart of a controller process according to another CD controller embodiment. An estimator objective function is formulated (700). The estimator objective function is optimized in order to estimate a most likely state subject to the state constraints (702). Various optimization techniques may be employed, including moving horizon estimation (MHE), nonlinear programming (NLP), quadratic programming (QP) as well as any other appropriate techniques. The estimated state is sent to the regulator (704), which has a regulator objective function. Based on the regulator objective function and subject to the constraints of the objective function, the regulator determines an optimal input using the estimated states (706). The optimal inputs are returned by the regulator (708), and then applied to the system (710). The outputs are then measured (712), and the state estimator updates the system state again and the process is repeated.

In this example, the estimator objective function is defined based on the difference between the measured outputs and the predicted outputs, expressed as:

$${min}_{{x}^{N}} {Φ}_{k} = {\sum }_{j = 0}^{N} {‖ {y}_{k + j}^{meas} - {y}_{k + j}^{pred} ‖}^{2} Q , \qquad ( 2 )$$

where y^{meas}ₖ₊ⱼ is the measurement, y^{pred}ₖ₊ⱼ is the prediction, and Q is a weighting matrix. By applying the model, the equation can be solved to obtain values that minimize the result of the estimator objective function, subject to the state constraints. In this example, such values are the most likely estimated state values.

Also in this embodiment, the regulator objective function is a scalar objective function defined as the following open loop quadratic equation:

$${min}_{{u}^{N}} {Φ}_{k} = {\sum }_{j = 0}^{N} {‖ {z}_{k + j}^{ref} - {z}_{k + j} ‖}^{2} Q + {‖ Δ {U}_{k + j} ‖}^{2} S , \qquad ( 3 )$$

where Q and S are the weighing matrices that penalize the deviation from target and the rate of change of the inputs, respectively, N is the prediction horizon, Zₖ^{ref} is the target, and Zₖ₊ⱼ is the prediction of the output. The function includes various system constraints such as the range of values for the inputs, u. Due to the constraints, the equation is not solved by doing a simple model inversion. Instead, techniques such as nonlinear programming and quadratic programming (QP) are used to solve this objective function.

In some embodiments, the system is operating in steady-state and does not have time dynamics. A prediction horizon of 1 is sometimes sufficient for solving the objective function. In some embodiments, the objective function may not be solvable because there are more states than available measurements. Under such circumstances, observability techniques may be applied to determine whether additional measurements should be performed.

In some embodiments, disturbances in the inputs, states and/or outputs may cause a mismatch or bias between the predictions and the actual measurements. A disturbance model is sometimes used to remove the steady-state offsets due to the mismatch.

According to the disturbance model, the error between the output measurements and the predicted outputs are due to integrated disturbances in one or more states, inputs or outputs. Thus, to remove the effects of the offsets, these integrating disturbances are integrated into the system model in some embodiments. More details of disturbance removal may be found in Middlebrooks and “Linear Model Predictive Control of Chemical Processes” by Kenneth Robert Muske (Ph.D. Dissertation, The University of Texas at Austin, May 1995), which is herein incorporated by reference for all purposes.

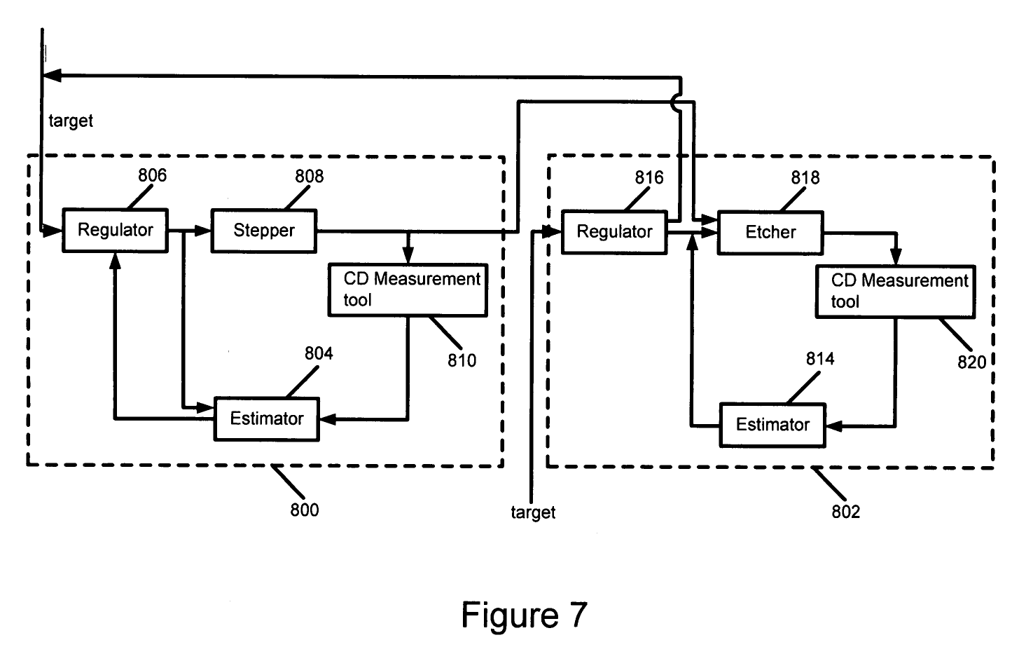

The examples shown above discuss extensively a develop inspect (DI) CD control system. The techniques are also applicable to other systems, such as a final inspect (FI) systems. In some embodiments, multiple controllers are cascaded to improve the CD of the overall system. FIG. 7 is a block diagram illustrating a cascaded critical dimension control system according to one embodiment. In this example, a DI CD system 800 is coupled with an Fl CD system 802. DI CD system 800 is similar to the critical dimension control system shown in FIG. 6. The input of etcher 818 includes the output of stepper 808, as well as other appropriate settings such as RF power, wafer temperature, reactor pressure, etc. Regulator 816 performs optimization based on its objective function, and drives the input of the etcher 818 to achieve the desired overall target. The etcher's output is measured by CD measurement tool 820. Estimator 814 derives the state of the FI CD system based on the input to the etcher and the measurement. The estimator output is then sent to regulator 816 to adjust the system model and drive the etcher to target.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of estimating a state of a critical dimension system, comprising:
inputting a critical dimension measurement; and
inferring the state of the system based on a model of the critical dimension system and the critical dimension measurements
wherein the critical dimension measurement includes a plurality of values measuring a plurality of system output characteristics.

2. A method as recited in claim 1, wherein the critical dimension measurement is obtained during develop inspect.

3. A method as recited in claim 1, wherein the critical dimension measurement is obtained during final inspect.

4. A method as recited in claim 1, wherein the critical dimension measurement is derived from device speed.

5. A method as recited in claim 1, wherein the critical dimension measurement is obtained using scatterometry.

6. A method as recited in claim 1, wherein the critical dimension measurement is obtained using ellipsometry.

7. A method as recited in claim 1, wherein the critical dimension measurement is measured across a die.

8. A method as recited in claim 1, wherein the critical dimension measurement is measured across a wafer.

9. A method as recited in claim 1, wherein the model includes a process model.

10. A method as recited in claim 1, wherein the inferred state includes a process disturbance.

11. A method as recited in claim 1, wherein the inferred state includes a process disturbance that is appended to the model.

12. A method of as recited in claim 1, wherein the inferred state includes an integrating process disturbance.

13. A method as recited in claim 1, wherein inferring the state of the system includes formulating an estimator objective function.

14. A method as recited in claim 1, wherein inferring the state of the system includes formulating an estimator objective function to minimize difference between the critical dimension measurement and a critical dimension prediction.

15. A method of as recited in claim 1, wherein inferring the state of the system includes using moving horizon estimation (MHE).

16. A method as recited in claim 1, wherein inferring the state of the system includes using non-linear programming.

17. A method of as recited in claim 1, wherein inferring the state of the system includes using quadratic programming.

18. A critical dimension controller comprising:
an interface configured to input a critical dimension measurement; and
an estimator configured to infer a state of a critical dimension system based on a model of the critical dimension system and the critical dimension measurement;
wherein the critical dimension measurement includes a plurality of values measuring a plurality of system output characteristics.

19. A computer program product for estimating a state of a critical dimension system, the computer program product being embodied in a computer readable medium and comprising computer instructions for:
inputting a critical dimension measurement; and
inferring the state of the system based on a model of the critical dimension system and the critical dimension measurement;
wherein the critical dimension measurement includes a plurality of values measuring a plurality of system output characteristics.

20. A method of estimating a state of a critical dimension system as recited in claim 1, wherein the state includes a parameter that describes a physical aspect of the system.
